(19) United States
(12) Patent Application Publication
(10) Pub. No.: US 2026/0261118 A1
(43) Pub. Date: Sep. 3, 2026

(54) ELECTRONIC DEVICE

(71) Applicant: Lenovo (Beijing) Limited, Beijing (CN)

(72) Inventors: Jiliang WANG, Beijing (CN); Huaqiao LI, Beijing (CN); Fenglong HE, Beijing (CN)

(21) Appl. No.: 19/538,361

(22) Filed: Feb. 12, 2026

(30) Foreign Application Priority Data
Feb. 28, 2025 (CN) 202510238163.1

(51) Int. Cl. H02J 1/10; H02J 7/00; H02J 7/35; H02J 7/80; H02J 7/90; H02J 101/24

(52) U.S. Cl. CPC H02J 1/10; H02J 7/35; H02J 7/80; H02J 7/855; H02J 7/933; H02J 2101/25

(57) ABSTRACT

An electronic device is provided. The electronic device includes a photovoltaic assembly, an electronic assembly, a power interface, a switch assembly, and a controller. The electronic assembly is configured to be powered for operations by a power supply other than the electronic assembly. The power interface is connected to the electronic assembly through the switch assembly, and is used to connect to an external power supply. The controller is configured to control at least one of the photovoltaic assembly or the external power supply to supply power to the electronic assembly based on electrical energy provided by the photovoltaic assembly and a connection status of the power interface with the external power supply, through the switch assembly.

### CROSS-REFERENCE TO RELATED APPLICATION

This application claims priority to Chinese Patent Application No. 202510238163.1, filed on February 28, 2025, the entire content of which is incorporated herein by reference.

### TECHNICAL FIELD

The present disclosure generally relates to the field of electronic device technologies and, more particularly, to an electronic device.

### BACKGROUND

Currently, most electronic devices rely on built-in batteries for power, resulting in significant limitations in battery life. To improve the battery life of electronic devices, solar panels are incorporated into the devices themselves. However, current solar panels in the electronic devices can only extend the battery’s range, and cannot provide power for the normal operation of the electronic devices when the electronic devices are in use.

### SUMMARY

In accordance with the present disclosure, there is provided an electronic device. includes a photovoltaic assembly, an electronic assembly, a power interface, a switch assembly, and a controller. The electronic assembly is configured to be powered for operations by a power supply other than the electronic assembly. The power interface is connected to the electronic assembly through the switch assembly, and is used to connect to an external power supply. The controller is configured to control at least one of the photovoltaic assembly or the external power supply to supply power to the electronic assembly based on electrical energy provided by the photovoltaic assembly and a connection status of the power interface with the external power supply, through the switch assembly.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 is a schematic structural diagram of an exemplary electronic device consistent with various embodiments of the present disclosure.

FIG. 2 is a schematic structural diagram of another exemplary electronic device consistent with various embodiments of the present disclosure.

FIG. 3 is a schematic structural diagram of another exemplary electronic device consistent with various embodiments of the present disclosure.

FIG. 4 is a schematic structural diagram of another exemplary electronic device consistent with various embodiments of the present disclosure.

FIG. 5 is a schematic structural diagram of another exemplary electronic device consistent with various embodiments of the present disclosure.

FIG. 6 is a schematic structural diagram of another exemplary electronic device consistent with various embodiments of the present disclosure.

FIG. 7 is a schematic diagram of a characteristic curve consistent with various embodiments of the present disclosure.

FIG. 8 is a schematic diagram of another characteristic curve consistent with various embodiments of the present disclosure.

FIG. 9 is a schematic structural diagram of another exemplary electronic device consistent with various embodiments of the present disclosure.

FIG. 10 is a schematic structural diagram of another exemplary electronic device consistent with various embodiments of the present disclosure.

### DETAILED DESCRIPTION OF THE EMBODIMENTS

Specific embodiments of the present disclosure are hereinafter described with reference to the accompanying drawings. The described embodiments are merely examples of the present disclosure and should not be regarded as limitations of this application. All other embodiments obtained by those of ordinary skill in the art without creative efforts fall within the scope of protection of the present disclosure.

Unless otherwise defined, all technical and scientific terms used in the present disclosure have the same meaning as those generally understood by those skilled in the art to which the present disclosure belongs. The terms used herein are only for the purpose of describing the present disclosure and are not intended to limit the scope of the present disclosure.

In the following description, “some embodiments”, “this embodiment”, one embodiment”, and “examples”, etc., describe subsets of all possible embodiments. But it is understood that “some embodiments” can be the same subset or different subsets of all possible embodiments, and can be combined with each other without conflict.

In the following description, the terms “first/second/third” or similar terms involved are only used to distinguish similar objects, and do not represent a specific order for the objects. It is understandable that items described by “first/second/third” may be interchanged with a specific order or sequence where permitted, such that the present disclosure described here can be implemented in an order other than that illustrated or described here.

In the present disclosure, the term “and/or” is only a kind of association relationship describing associated objects, indicating that there can be three types of relationships. For example, “object A and/or object B” may iinclude: object A exists alone, object A and object B exist at the same time, or object B exists alone.

Unless otherwise defined, all technical and scientific terms used herein have the same meaning as commonly understood by one of ordinary skill in the art to which the present disclosure belongs. The terminology used herein is for descriptive purposes only and is not intended to limit the scope of the present disclosure.

A solar-powered laptop includes a solar panel and a battery. However, the solar panels can only charge the battery when the solar-powered laptop is not powered on. That is, when a user is using the solar-powered laptop, the solar panel cannot charge the battery or power the laptop’s system. Therefore, solar charging and user operation cannot coexist, resulting in insufficient utilization of solar energy.

The present disclosure provides an electronic device to at least partially alleviate the above problems. Exemplarily, this electronic device may be, but is not limited to, a smartphone, a tablet, a wearable device, a personal computer (PC), a laptop, etc., and the present disclosure does not limit this.

In one embodiment shown in FIG. 1 which is a schematic diagram of an electronic device provided by the present disclosure, the electronic device 100 may include a photovoltaic assembly 110, an electronic assembly 120, a power interface 130, a switch assembly 140, and a controller (not shown in the figure). The electronic assembly 120 may be a component that operates by being powered by a power supply other than the one shown in the figure. The power interface 130 may be connected to the electronic assembly 120 through the switch assembly 140.

The power interface 130 may be used to connect to an external power supply (not shown in the figure).

The controller may be used to control at least one of the photovoltaic assembly 110 or the external power supply to supply power to the electronic assembly 120 based on the electrical energy provided by the photovoltaic assembly 110 and the connection status of the power interface 130 to the external power supply, via the switch assembly 140.

In one embodiment, the electronic device may further include an acquisition unit. The acquisition unit may be used to acquire the electrical energy generated by the photovoltaic assembly and send the acquired electrical energy to the controller. The controller may determine whether the photovoltaic assembly starts converting solar energy into electrical energy based on the acquired electrical energy. For example, the acquisition unit may include at least one of a current acquisition unit, a voltage acquisition unit, or a power acquisition unit. Correspondingly, the electrical energy may include at least one of the current provided by the photovoltaic assembly, the voltage provided by the photovoltaic assembly, or the power provided by the photovoltaic assembly. The controller may be an embedded controller (EC).

In one embodiment, the connection status of the power interface to the external power supply may indicate whether the power interface is connected to the external power supply. In some embodiments, the electronic device may further include an interface sensing unit configured to monitor in real time whether the power interface is connected to a device and, if so, determine the type of the device. The interface sensing unit may send the connection status of the power interface to the controller. For example, the interface sensing unit may be a power delivery (PD) assembly.

In one embodiment, the photovoltaic assembly may be connected to the electronic assembly. That is, the on and off of the switch assembly in the electronic device may not affect the photovoltaic assembly’s power supply to the electronic assembly. Thus, when the electronic assembly needs to operate, the electrical energy generated by the photovoltaic assembly may provide power to the electronic assembly, thereby improving the utilization rate of solar energy. The aforementioned electronic assembly may be a component that operates by being powered by a power supply other than the electronic assembly itself. That is, the electronic assembly itself may not have a power supply and may need to be powered by a power supply other than the electronic assembly (such as an energy storage module in the electronic device, a working photovoltaic assembly, or an external power supply). For example, the electronic assembly may be a central processing unit (CPU), a graphics processing unit (GPU), an SSD, memory, a network card, a display screen, etc.

In some embodiments, the switch assembly may include a control port, and a controller may be connected to the control port of the switch assembly. The controller may generate a control signal for turning on or off based on the electrical energy provided by the photovoltaic assembly and the connection status of the power interface with an external power supply, and then may send the generated control signal to the control port of the switch assembly to turn the switch assembly on or off.

In one embodiment, the controller may determine whether the photovoltaic assembly starts photoelectric conversion based on the electrical energy provided by the photovoltaic assembly, and determine whether an external power supply is connected to the electronic device based on the connection status of the power interface with an external power supply. Thus, the controller may control the photovoltaic assembly to supply power to the electronic assembly when the photovoltaic assembly is working and no external power supply is connected, or control the external power supply to supply power to the electronic assembly when the photovoltaic assembly is not working and the external power supply is connected, or control both the photovoltaic assembly and the external power supply to supply power to the electronic assembly when the photovoltaic assembly is working and the external power supply is connected. Thus, when the electronic device is powered on, the photovoltaic assembly may also power the operating electronic assembly, thereby improving the utilization rate of solar energy.

In some embodiments, when the connection status indicates that the power interface is connected to the external power supply and the photovoltaic assembly is capable of generating electrical energy, the switch assembly may be turned on, allowing both the photovoltaic assembly and the external power supply to jointly power the electronic assembly.

As shown in FIG. 1, when the photovoltaic assembly 110 generates electrical energy, it may power the electronic assembly. When the power interface 130 is connected to an external power supply, the controller may control the switch assembly 140 to turn on, thereby enabling the external power supply to power the electronic assembly.

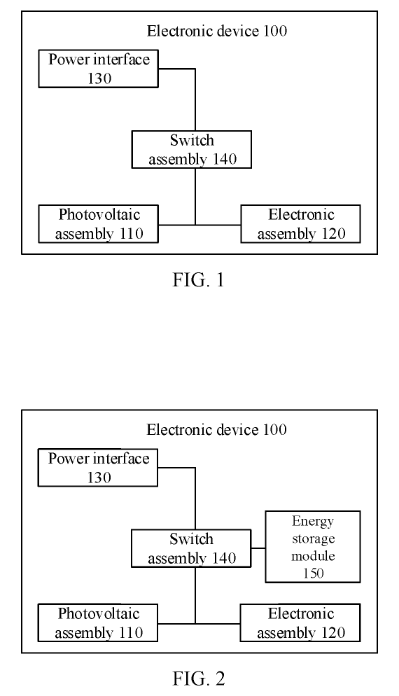

In some embodiments, as shown in FIG. 2, the electronic device 100 may further include an energy storage module 150. The photovoltaic assembly 110 may be connected to one end of the electronic assembly 120 and may be connected to the energy storage module 150 via the switch assembly 140. The power interface 130 may be connected to both the energy storage module 150 and the electronic assembly 120 via the switch assembly 140. The controller may be configured to, based on the electrical energy provided by the photovoltaic assembly and the connection status of the power interface with an external power supply, control at least one of the photovoltaic assembly 110, the energy storage module 150, or the external power supply to supply power to the electronic assembly 120, and/or, based on the electrical energy provided by the photovoltaic assembly and the connection status of the power interface with an external power supply, control at least one of the photovoltaic assembly 110 or the external power supply to charge the energy storage module 150 via the switch assembly 140.

In some embodiments, if the photovoltaic assembly generates electrical energy and the connection status indicates that the power interface is not connected to an external power supply, when the electronic assembly starts working, the system voltage of the electronic device may be reduced. At this time, the voltage corresponding to the photovoltaic assembly may be larger than the system voltage, such that the photovoltaic assembly supplies power to the electronic assembly. When the power provided by the photovoltaic assembly meets the needs of the electronic assembly, the system voltage may remain constant. At this time, the switch assembly may be in the turn-on state because the output voltage of the photovoltaic assembly is larger than the voltage of the energy storage module and the photovoltaic assembly may charge the energy storage module. When the power provided by the photovoltaic assembly cannot meet the needs of the electronic assembly, the system voltage may continue to drop. At this time, the photovoltaic assembly may actively reduce its own output voltage until the output voltage of the photovoltaic assembly equals the voltage of the energy storage module. Because the electronic assembly may be in the working state, it may continuously increase its power demand, causing the system voltage to continue to drop until the system voltage is less than the voltage of the energy storage module. At this time, the energy storage module may supply power to the electronic assembly. For example, when the photovoltaic assembly generates electrical energy and the connection status indicates that the power interface is not connected to an external power supply, the controller may turn on the switch assembly.

When the photovoltaic assembly generates electrical energy and the connection status indicates that the power interface is not connected to an external power supply, the photovoltaic assembly may prioritize powering the electronic assembly. When the Photovoltaic assembly is able to meet the power needs of the electronic assembly, it may also charge the energy storage module. When the photovoltaic assembly cannot meet the power needs of the electronic assembly, the energy storage module may power the electronic assembly. This further improves the utilization rate of solar energy.

When the photovoltaic assembly generate electrical energy and the connection indicates that the power interface is connected to an external power supply, by controlling the switch assembly, it may be possible to achieve the following: the photovoltaic assembly powers the electronic assembly while the external power supply charges the energy storage module; or the photovoltaic assembly and the external power supply power the electronic assembly while the external power supply charges the energy storage module; or the photovoltaic assembly, the energy storage module, and the external power supply jointly power the electronic assembly. This improves the flexibility of the power supply from the photovoltaic assembly, the energy storage module, and the external power supply.

In some embodiments, when the photovoltaic assembly generates electrical energy and the connection status indicates that the power interface is connected to an external power supply, the controller may control the external power supply to charge the energy storage module and control the photovoltaic assembly to power the electronic assembly through the switch assembly. When the power provided by the photovoltaic assembly is insufficient to meet the needs of the electronic assembly, the system voltage may continue to drop. At this time, the controller may control the external power supply to power the electronic assembly through the switch assembly. It is understood that because the system voltage may continue to drop, when the system voltage is lower than the output voltage of the external power supply, the charging path from the external power supply to the energy storage module may be shunted by the lower system voltage, such that a portion of the charging power is used to compensate for the electronic assembly and a remaining portion is used to charge the energy storage module. As the power demand of the electronic assembly increases further, the system voltage may continue to decrease until the charging power provided by the external power supply fully compensates for the electronic assembly. At this point, the energy storage module may stop charging and, influenced by the lower system voltage, discharge back into the system. This allows the photovoltaic assembly, the energy storage module, and the external power supply to jointly power the electronic assembly.

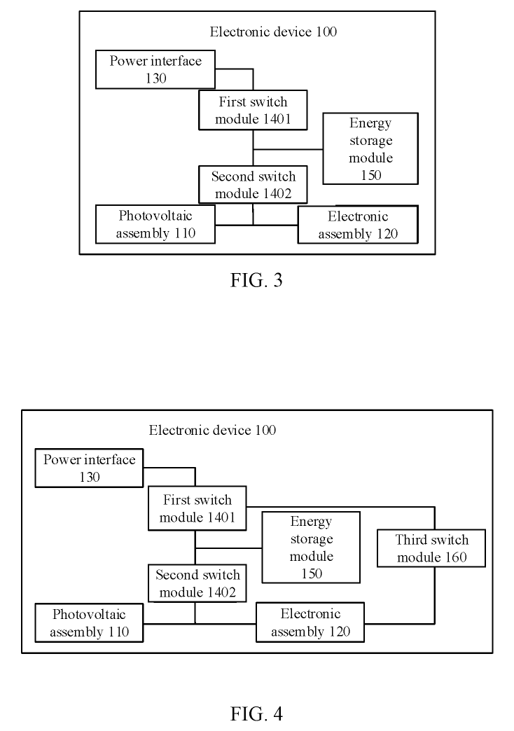

In some embodiments, as shown in FIG. 3, the switch assembly may include a first switch module 1401 and a second switch module 1402. The power interface 130 may be connected to a first terminal of the first switch module 1401, and a second terminal of the first switch module 1401 may be connected to the energy storage module 150 and a first terminal of the second switch module 1402, respectively. A second terminal of the second switch module 1402 may be connected to the photovoltaic assembly 110 and the electronic assembly 120, respectively.

In one embodiment, the controller may be used to turn on the second switch module and turn off the first switch module when the connection status indicates that the power interface is not connected to an external power supply and the photovoltaic assembly generates electrical energy, thereby causing the photovoltaic assembly to supply power to the electronic assembly, or causing the photovoltaic assembly to supply power to the electronic assembly and charge the energy storage module.

It is understood that when the connection status indicates that the power interface is not connected to an external power supply and the photovoltaic assembly generates electrical energy, the operating electronic assembly may reduce the system voltage of the electronic device. At this time, the output voltage of the photovoltaic assembly may be larger than the system voltage, and the photovoltaic assembly may supply power to the electronic assembly. When the power supplied by the photovoltaic assembly is sufficient to meet the needs of the electronic assembly, the system voltage may remain constant. At this time, the second switch module may be turned on because the output voltage of the photovoltaic assembly is larger than the voltage of the energy storage module, allowing the photovoltaic assembly to charge the energy storage module. When the power supplied by the photovoltaic assembly is insufficient to meet the needs of the electronic assembly, the system voltage may continuously decrease. The photovoltaic assembly may then actively reduce its output voltage until it equals the voltage of the energy storage module. Because the electronic assembly is active, its power demand may continuously increase, causing the system voltage to continue to decrease until it falls below the voltage of the energy storage module. At this point, the energy storage module may supply power to the electronic assembly.

In one embodiment, the controller may acquire the voltage of the energy storage module and then set the output voltage of the photovoltaic assembly based on this voltage, where the output voltage of the photovoltaic assembly is larger than the voltage of the energy storage module.

In one embodiment, when the connection status indicates that the power interface is connected to an external power supply and the photovoltaic assembly generates electrical energy, the second switch module and the first switch module may be turned on, causing the external power supply and the photovoltaic assembly to perform one of the following:

the external power supply charges the energy storage module, and the photovoltaic assembly supplies power to the electronic assembly; or

the external power supply charges the energy storage module, and the photovoltaic assembly and the external power supply jointly supply power to the electronic assembly; or

the photovoltaic assembly, the external power supply, and the energy storage module jointly supply power to the electronic assembly.

In one embodiment, when the system voltage of the electronic device remains constant during the process of the photovoltaic assembly supplying power to the electronic assembly, the controller may turn off the second switch module to prevent the photovoltaic assembly from charging the energy storage module while the external power supply is charging the energy storage module. At this time, the external power supply may charge the energy storage module, and the photovoltaic assembly may supply power to the electronic assembly.

In some embodiments, when the system voltage of the electronic device decreases during the process of the photovoltaic assembly supplying power to the electronic assembly, the controller may turn on the second switch module to allow the external power supply to supply power to the electronic assembly. Understandably, because the system voltage will continuously decrease, when the system voltage is lower than the output voltage of the external power supply, the charging path from the external power supply to the energy storage module may be shunted by the lower system voltage. Therefore, a portion of the charging power may be used to compensate for the electronic assembly, and a remaining portion may be used to charge the energy storage module. At this time, the external power supply may charge the energy storage module, and the photovoltaic assembly and the external power supply may jointly power the electronic assembly.

As the power demand of the electronic assembly further increases, the system voltage may continue to decrease until the charging power provided by the external power supply fully compensates for the electronic assembly. The energy storage module may then stop charging and, influenced by the even lower system voltage, may discharge back into the system. At this point, the photovoltaic assembly, the external power supply, and the energy storage module may jointly power the electronic assembly.

In some embodiments, as shown in FIG. 4, the electronic device 100 may further include a third switch module 160. The power interface 130 may be connected to the electronic assembly 120 through the third switch module 160.

The controller may be configured to:

when the power interface is not connected to an external power supply and the photovoltaic assembly is not generating current, turn off the second switch module and turn on the first switch module and the third switch module, allowing the energy storage module to supply power to the electronic assembly;

when the power interface is not connected to an external power supply and the photovoltaic assembly is generating current, turn off the first switch module and the third switch module and turn on the second switch module;

when the power interface is connected to an external power supply and the photovoltaic assembly is not generating current, turn off the second switch module and turn on the first switch module and the third switch module, allowing the external power supply to supply power to the electronic assembly and charge the energy storage module; or

when the power interface is connected to an external power supply and the photovoltaic assembly is generating current, turn off the third switch module and turn on the first and second switch modules, or turn off the third switch module and the second switch module and turn on the first switch module.

It is understandable that when the power interface is not connected to an external power supply and the photovoltaic assembly does not generate current, the energy storage module may supply power to the electronic assembly through the first switch module and the third switch module.

When the power interface is not connected to an external power supply and the photovoltaic assembly generates current, the second switch module may be turned on, allowing the photovoltaic assembly to power both the electronic assembly and charge the energy storage module. The energy storage module and the photovoltaic assembly may also jointly power the electronic assembly.

When the power interface is connected to an external power supply and the photovoltaic assembly does not generate current, the second switch module may be turned off, while the first switch module and the third switch module may be turned on. In this case, the external power supply may power the electronic assembly through the first switch module and the third switch module and charge the energy storage module through the first switch module.

When the power interface is connected to an external power supply and the photovoltaic assembly generates current, if the system voltage of the electronic device remains constant, it may be indicated that the photovoltaic assembly is able to meet the power requirements of the electronic assembly. At this time, the controller may turn off the third and second switch modules and turn on the first switch module, allowing the external power supply to charge the energy storage module, and the photovoltaic assembly to supply power to the electronic assembly. If the system voltage of the electronic device drops, it may indicate that the photovoltaic assembly cannot meet the power demand of the electronic module. At this time, the controller may turn off the third switch module and turn on the first switch module and the second switch module. At this time, the external power supply may charge the energy storage module, and the photovoltaic assembly and the external power supply may jointly supply power to the electronic assembly, or the photovoltaic assembly, the external power supply and the energy storage module may jointly supply power to the electronic assembly.

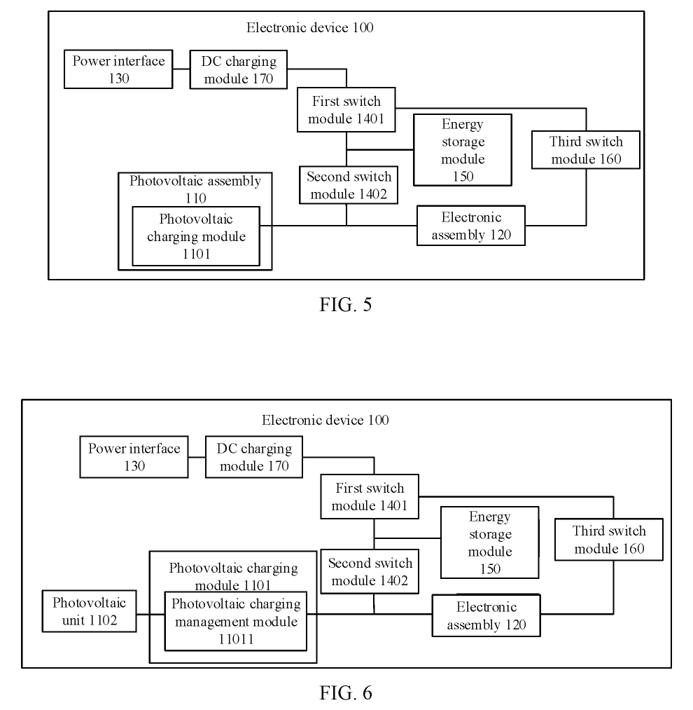

In some embodiments, as shown in FIG. 5, the photovoltaic assembly 110 may include a photovoltaic charging module 1101. The electronic device 100 may further include a DC charging module 170. The DC charging module 170 may be connected to the power interface 130.

The controller may be configured to acquire voltage information of the energy storage module when the connection status indicates that the power interface is connected to an external power supply and the photovoltaic assembly generates electrical energy.

The controller may be configured to determine, based on the voltage information of the energy storage module, a first output voltage information of the photovoltaic charging module and a second output voltage information of the DC charging module, where the first output voltage information and the second output voltage information may be larger than the voltage information of the energy storage module.

The photovoltaic charging module may be configured to supply power to the electronic module based on the first output voltage information, and/or charge the energy storage module based on the first output voltage information.

The DC charging module may be configured to supply power to the electronic module based on the second output voltage information, and/or charge the energy storage module based on the second output voltage information.

In one embodiment, when the connection status indicates that the power interface is connected to an external power supply and the photovoltaic assembly generates electrical energy, the controller may obtain the voltage information of the energy storage module via the Inter-Integrated Circuit (I2C) protocol.

It may be understood that for the photovoltaic assembly and the external power supply to power the electronic assembly and charge the energy storage module, the output voltage of the photovoltaic assembly and the external power supply may need to be lower than the voltage of the energy storage module. Therefore, by setting the charging voltage for the photovoltaic charging module and the DC charging module in the photovoltaic assembly, the controller may enable the photovoltaic assembly and the external power supply to power the electronic assembly and charge the energy storage module.

In some embodiments, the photovoltaic charging module may be a Maximum Power Point Tracking Charger (MPPT Charger), and the DC charging module may be a Narrow Voltage Direct Current Charger (NVDC Charger).

In some embodiments, as shown in FIG. 6, the photovoltaic assembly may include a photovoltaic charging module 1101 and a photovoltaic unit 1102. The photovoltaic charging module 1101 may include a photovoltaic charging management module 11011.

The controller may be configured to: acquire current information and voltage information of the photovoltaic unit; determine the maximum input power of the photovoltaic unit based on the current information and voltage information of the photovoltaic unit; determine the power supply strategy of the photovoltaic charging management module based on the maximum input power of the photovoltaic unit.

In one embodiment, the photovoltaic unit may be a solar panel used to convert solar energy into electrical energy. The acquisition unit in the electronic device may acquire multiple pieces of current information and multiple pieces of voltage information of the photovoltaic unit within a predetermined time period, and send the real-time acquired multiple pieces of current information and multiple pieces of voltage information to the controller.

In one embodiment, after obtaining multiple pieces of current information and multiple pieces of voltage information of the photovoltaic unit within the predetermined time period, the controller may determine the characteristic curve of the photovoltaic unit under the predetermined time period based on the multiple pieces of current information and multiple pieces of voltage information, and determine the maximum input power of the photovoltaic unit based on the characteristic curve.

In some embodiments, the current/voltage response curve of the photovoltaic unit during the predetermined time period may be determined first based on multiple pieces of current information and multiple pieces of voltage information, and then the characteristic curve may be determined based on the current/voltage response curve.

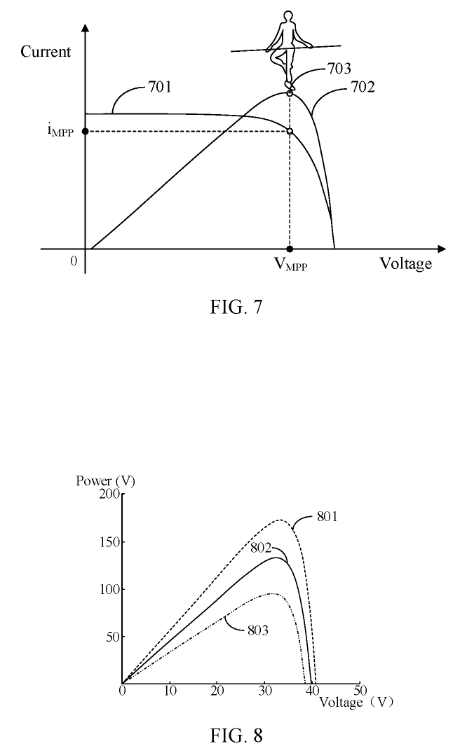

For example, as shown in FIG. 7, the curve 701 is the current/voltage response curve of the photovoltaic unit during a certain period. Based on the curve 701, the characteristic curve 702 may be obtained. Based on the characteristic curve 702, the maximum input power 703 of the photovoltaic unit during that period may be obtained. As shown in FIG. 8, the curve 801 is the characteristic curve of the photovoltaic unit when the battery is at 25°C and the irradiance is 1000W/m²; the curve 802 is the characteristic curve of the photovoltaic unit when the battery is at 25°C and the irradiance is 800W/m²; and the curve 803 is the characteristic curve of the photovoltaic unit when the battery is at 25°C and the irradiance is 600W/m².

In one embodiment, the controller may acquire the current and voltage generated by the photovoltaic unit in real time when converting solar energy, then determine the maximum input power of the photovoltaic unit based on the current and voltage generated by the photovoltaic unit, and finally adjust the power supply strategy of the photovoltaic charging management module in real time based on the maximum input power of the photovoltaic unit. In this way, the power supply strategy of the photovoltaic charging management module may match the maximum input power of the photovoltaic unit, thereby improving the utilization rate of solar energy.

In some embodiments, the above controller may be an independent controller, such as an EC, a CPU, or an artificial intelligence chip (AI chip). In other embodiments, the controller may further include multiple control submodules, which communicate with each other to complete the control functions of the entire controller. For example, the control submodules in the controller may be an EC (Electronic Control Unit), a CPU, etc.

In some embodiments, the controller may be further configured to: determine a target power range among predetermined multiple power ranges based on the maximum input power of the photovoltaic unit; and determine the output current range (i.e., range of the output current) corresponding to the target power range as the power supply strategy of the photovoltaic charging management module.

In one embodiment, the power range into which the maximum input power falls among multiple power ranges may be determined as the target power range.

In one embodiment, different power ranges may correspond to different output current ranges, and the controller may determine the output current range corresponding to the target power range based on the target power range and multiple correspondences.

In one embodiment, the power supply strategy of the photovoltaic charging management module may refer to the photovoltaic charging management module using current within the output current range to supply power to the electronic assembly and/or the energy storage module.

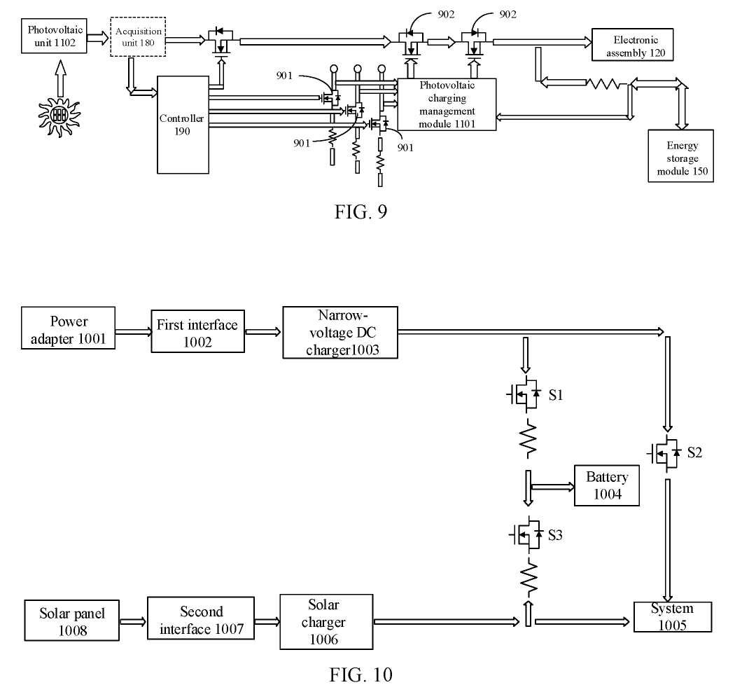

In some embodiments, as shown in FIG. 9, the electronic device may further include a plurality of fourth switch modules 901 and a fifth switch module 902. The number of the plurality of fourth switch modules 901 may correspond to the number of the power ranges. The controller 190 may be connected to the photovoltaic charging management module 1101 through the plurality of fourth switch modules 901. The photovoltaic charging module may further include the fifth switch module 902, and may be connected to the electronic assembly 120 through the fifth switch module 902.

The controller may be used to turn on one fourth switch module corresponding to the target power range.

The photovoltaic charging management module may be used to turn on the fifth switch module based on the high-level signal generated by the turning on of the fourth switch module, such that the current value through the fifth switch module is within the output current range.

As shown in FIG. 9, when the photovoltaic unit 1102 converts solar energy into electrical energy, the acquisition unit 180 may acquire the current and voltage of the photovoltaic unit 1102 and send them to the controller 190. Based on the current and voltage of the photovoltaic unit 1102, the controller 190 may determine the maximum input power of the photovoltaic unit 1102 and then determine the target power range within which the maximum input power falls. Then, the controller 190 may turn on one fourth switch module 901 corresponding to the target power range. The controller 190 may transmit a high-level signal to the photovoltaic charging management module 1101 through the fourth switch module 901 which is turned on. The photovoltaic charging management module 1101, based on the high- level signal, may turn on the fifth switch module 902, ensuring that the current value through the fifth switch module 902 is within the output current range.

In one embodiment, after determining the target power range, the controller may transmit a level signal to the fourth switch module corresponding to the target power range to turn on the fourth switch module, thereby achieving the turning on of the fourth switch module corresponding to the target power range. For example, the plurality of fourth switch modules may be transistors, and the controller may transmit a level signal to a base of a transistor to turn on one corresponding fourth switch module.

In one embodiment, when the fifth switch module is a transistor, the controller may control the current flowing into the base of the fifth switch module, thereby ensuring that the current value through the fifth switch module is within the output current range.

In some embodiments, the controller may be further configured to send indication information carrying the output current range to the photovoltaic charging management module. The photovoltaic charging management module may be configured to determine voltage information corresponding to the output current range based on the indication information; and based on the voltage information corresponding to the output current range, turn on the fifth switch module, ensuring that the current value through the fifth switch module 902 is within the output current range.

In some embodiments, the electronic device may further include a power limiting module. The controller may be configured to determine the power limiting range of the electronic assembly based on the target power range of the photovoltaic unit. The controller may also be configured to send the power limiting range of the electronic assembly to the power limiting module; and the power limiting module may be configured to limit the load power of the electronic assembly based on the power limiting range. For example, the power limiting module may be a basic input/output system (BIOS).

In one embodiment, after determining the target power range based on the maximum input power, the controller may determine the power limiting range of the electronic assembly based on the target power range of the photovoltaic unit. The controller may store a correspondence between different power ranges and different power limiting ranges, and may determine the power limiting range of the electronic assembly using this correspondence.

For example, when the electronic assembly is a CPU and the target power range is above 9.62W, the CPU’s power limit range may be PL1 of PL1, PL2, or PL3. When the target power range is from 7.62W to 9.62W, the CPU’s power limit range may be PL2; and when the target power range is below 7.62W, the CPU’s power limit range may be PL3.

In one embodiment, while determining the power supply strategy of the photovoltaic charging management module, the controller may determine the power limit range of the electronic assembly corresponding to the target power range, and then limit the load power of the electronic assembly based on the power limit range through the power limit module. This may ensure that the load power of the electronic assembly conforms to the power supply strategy of the photovoltaic assembly, thereby enabling the electronic device to operate normally and fully utilize the electrical energy converted from solar energy, reducing unnecessary losses and lowering energy costs.

The present disclosure also provides a control method applied to the aforementioned controller. The control method may include:

S101: obtaining current and voltage information of the photovoltaic unit;

S102: determining the maximum input power of the photovoltaic unit based on the current and voltage information;

S103: determining the power supply strategy of the photovoltaic charging management module based on the maximum input power of the photovoltaic unit.

In some embodiments, S103 may include:

S1031: determining the target power range among predetermined power ranges based on the maximum input power of the photovoltaic unit;

S1032: determining the output current range corresponding to the target power range as the power supply strategy of the photovoltaic charging management module.

In some other embodiments, the control method may include:

S201: determining the power limitation range of the electronic assembly based on the target power range of the photovoltaic unit; and

S202: sending the power limitation range of the electronic assembly to the power limitation module, where the power limitation module is used to limit the load power of the electronic assembly based on the power limitation range.

The present disclosure also provides a strategy setting method for a solar charger. The strategy setting method may include:

S301: The EC determines the characteristic curve of the solar panel based on measured data of the solar panel, where the measured data of the solar panel may be the voltage and current of the solar panel;

S302: The EC determines the maximum input power of the solar panel based on the characteristic curve;

S303: The EC determines a target range among three pre-set ranges based on the maximum input power of the solar panel, where, for example, the three pre-set ranges may include 7W to 9W, 9W to 13W, and above 13W, and each range corresponds to the current setting of the solar charger.

S304: Based on the target range, the EC activates the target switch among multiple switches corresponding to the target range, or the EC sends indication information corresponding to the target range to the management module of the solar charger based on a communication protocol.

S305: The EC sends the power limit setting corresponding to the target range to the basic input/output system.

S306: The management module of the solar charger receives a high-level signal corresponding to the target switch and determines the corresponding voltage information based on the high-level signal, or the management module of the solar charger determines the corresponding voltage information in response to the indication information.

S307: The management module of the solar charger turns on the switch module based on the voltage information, causing the solar charger to provide the electronic device with a current corresponding to the target range.

S308: The basic input/output system limits the load power of the electronic device based on the power limit setting.

In some embodiments, as shown in FIG. 10, the electronic device may include a first interface 1002 (corresponding to the power interface in the above embodiments), a narrow-voltage DC charger 1003 (corresponding to the DC charging module in the above embodiments), a first switch S1 (corresponding to the first switch module in the above embodiments), a second switch S2 (corresponding to the third switch module in the above embodiments), a third switch S3 (corresponding to the second switch module in the above embodiments), a battery 1004 (corresponding to the energy storage module in the above embodiments), a system 1005 (corresponding to the electronic assembly in the above embodiments), a solar charger 1006 (corresponding to the photovoltaic charging module in the above embodiments), a second interface 1007, and a solar panel 1008 (corresponding to the photovoltaic unit in the above embodiments). The power adapter 1001 may be connected to the narrow-voltage DC charger 1003 via the first interface 1002, and the narrow-voltage DC charger 1003 may be connected to the battery 1005 via the first switch S1. The narrow-voltage DC charger 1003 may be connected to the system 1005 via the second switch S2. The battery 1005 may be connected to the system 1005 via the third switch S3. The solar panel 1008 may be connected to the solar charger 1006 via the second interface 1007. The solar charger 1006 may be connected to the battery 1004 via the third switch S3. The solar charger 1006 may be connected to the system 1005.

The first interface 1002 may be a Type-C interface for connection to the power adapter 1001. The second interface 1007 may be a motherboard connector (MB Conn).

In one embodiment, the PD (Power Delivery) module in the electronic device may identify whether a power adapter is connected. When no power adapter is connected, EC may control S3 to be disconnected, entering a DC-only mode, while S1 and S2 are connected, and the battery may supply power to the system. The PD module may be a chip on the electronic device responsible for the PD protocol. This chip may use the PD protocol to communicate with the Type-C adapter to determine the adapter type and its presence.

When the solar panel receives solar energy, S1 and S2 may be disconnected, and S3 may be turned on. The solar energy may supply power to the system and charge the battery through the solar charger. When the solar power exceeds the system demand, the excess power may be used to charge the battery. When the solar power is less than the system demand, the insufficient power may be dynamically compensated by the battery discharging.

The EC may obtain the battery voltage via a two-wire serial bus (Inter-Integrated Circuit, I2C) protocol directly.

The EC may then actively set an output voltage for the solar charger based on the battery voltage, which corresponds to the system voltage. The output voltage may be larger than the battery voltage. Because the battery voltage and system voltage have a linear relationship, the output voltage set based on the battery voltage may correspond to the system voltage.

When the system power demand increases, the system voltage may be lowered, and the solar charger may maintain a constant system voltage by outputting current. When the solar power exceeds the system demand, the system voltage may not change because the output voltage is larger than the battery voltage, such that the solar charger may continue to charge the battery.

When the system demand exceeds the solar energy output power, the current output by the solar charger cannot maintain the system voltage, causing the system voltage to drop. When the system voltage continues to drop (i.e., the solar energy output power is less than the system demand power), the solar charger may reduce its own output voltage until it equals the battery voltage. At this point, the solar charger may fully supply power to the system. When the system continues to increase its power demand, the system voltage may continue to drop, eventually falling below the battery voltage and causing the battery to discharge into the system.

In one embodiment, when the power adapter is connected, S3 may be turned off, entering an AC mode, while S1 and S2 may be turned on such that the power adapter supplies power to the system and charges the battery.

In one embodiment, when the solar panel receives solar energy, S2 may be turned off, S3 and S1 may be turned on, such that the solar energy prioritizes supplying power to the system and the power adapter charges the battery.

It is understood that when the electronic device is connected to the power adapter and receives solar energy from the solar panel, the EC may set the output voltage of the narrow-voltage DC charger and the solar charger based on the battery voltage. The narrow-voltage DC charger may be set to a voltage higher than the battery voltage to charge the battery. Because of the uncontrollable risks of parallel battery charging, the EC may turn off S3 when it determines that the electronic device is connected to the power adapter and the solar panel to obtain solar energy, thus preventing the solar charger from charging the battery, allowing the power adapter to charge the battery.

In one embodiment, when the solar panel obtains solar energy, S3 may be turned on, and the power adapter may provide power to compensate for insufficient system power.

It can be understood that when the output power of the solar charger is larger than the system power, the power adapter may charge the battery, and the solar panel may supply power to the system. When the system power is larger than the solar power, the system voltage may be lower than the battery voltage. In this case, the charging path from the power adapter to the battery may be shunted by the lower system voltage, causing a portion of the charging power to compensate for the system, while a remaining portion is used to charge the battery. This may allow the power adapter and solar charger to jointly provide power to the system.

When the total power of the power adapter and solar charger is still insufficient to meet the system’s demand, the battery may discharge to complete the compensation power supply to the system. When the system voltage is lower than the battery voltage, the solar charger may supply all power to the system, and the charging power of the power adapter may be affected by the lower system voltage, with a portion of the charging power being shunted to the system. When the system’s power demand increases further, it may cause the system voltage to drop excessively until the charging power provided by the power adapter fully compensates for the system demand. At this point, the battery may stop charging and may be affected by the even lower system voltage, thus discharging into the system. A three-way power supply to the system from the battery, solar charger, and power adapter may be achieved.

The various specific technical features described in the specific embodiments can be combined in any suitable manner without contradiction. For example, different embodiments and technical solutions can be formed by combining different specific technical features. In order to avoid unnecessary repetition, the various possible combinations of the specific technical features in this application will not be described separately.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. An electronic device, comprising a photovoltaic assembly, an electronic assembly, a power interface, a switch assembly, and a controller, wherein
the electronic assembly is configured to be powered for operations by a power supply other than the electronic assembly;
the power interface is connected to the electronic assembly through the switch assembly, and is connected to an external power supply; and
the controller is configured to control at least one of the photovoltaic assembly or the external power supply to supply power to the electronic assembly based on electrical energy provided by the photovoltaic assembly and a connection status of the power interface with the external power supply, through the switch assembly.

2. The device according to claim 1, wherein the controller is further configured to:
when the connection status indicates that the power interface is connected to the external power supply and the photovoltaic assembly generates electrical energy, turn on the switch assembly such that the photovoltaic assembly and the external power supply jointly supply power to the electronic assembly.

3. The device according to claim 1, further comprising an energy storage module, wherein:
the photovoltaic assembly is connected to the energy storage module via the switch assembly; and
the power interface is connected to both the energy storage module and the electronic assembly via the switch assembly.

4. The device according to claim 3, wherein the controller is configured to:
control at least one of the photovoltaic assembly, the energy storage module, and the external power supply to supply power to the electronic assembly based on the electrical energy provided by the photovoltaic assembly and the connection status of the power interface with the external power supply, and/or
control at least one of the photovoltaic assembly and the external power supply to charge the energy storage module based on the electrical energy provided by the photovoltaic assembly and the connection status of the power interface with the external power supply.

5. The device according to claim 4, wherein:
the switch assembly includes a first switch module and a second switch module; and
the controller is configured to:
when the connection status indicates that the power interface is not connected to the external power supply and the photovoltaic assembly generates electrical energy, turn on the second switch module and turn off the first switch module, such that the photovoltaic assembly supplies power to the electronic assembly, or such that the photovoltaic assembly supplies power to the electronic assembly and charges the energy storage module.

6. The device according to claim 5, wherein the controller is configured to:
when the connection status indicates that the power interface is connected to the external power supply and the photovoltaic assembly generates electrical energy, turn on the second switch module and the first switch module, such that the external power supply and the photovoltaic assembly perform at least one of following:
the external power supply charges the energy storage module and the photovoltaic assembly supplies power to the electronic assembly;
the external power supply charges the energy storage module and the photovoltaic assembly and the external power supply jointly supply power to the electronic assembly; or
the photovoltaic assembly, the external power supply, and the energy storage module jointly supply power to the electronic assembly.

7. The device according to claim 6, further comprising a third switch module, wherein the power interface is connected to the electronic assembly via the third switch module.

8. The device according to claim 7, wherein the controller is configured to:
when the power interface is not connected to the external power supply and the photovoltaic assembly is not generating current, turn off the second switch module and turn on the first switch module and the third switch module to allow the energy storage module to supply power to the electronic assembly.

9. The device according to claim 7, wherein the controller is configured to:
when the power interface is not connected to the external power supply and the photovoltaic assembly is generating current, turn off the first switch module and the third switch module and turn off the second switch module.

10. The device according to claim 7, wherein the controller is configured to:
when the power interface is connected to the external power supply and the photovoltaic assembly is not generating current, turn off the second switch module and turn on the first switch module and the third switch, allowing the external power supply to supply power to the electronic assembly and charge the energy storage module.

11. The device according to claim 7, wherein the controller is configured to:
when the power interface is connected to the external power supply and the photovoltaic assembly is generating current, turn off the third switch module and turn on the first switch module and the second switch module, or turn off the third switch module and the second switch module and turn on the first switch module.

12. The device according to claim 4, wherein:
the photovoltaic assembly includes a photovoltaic charging module;
the electronic device further includes a DC charging module connected to the power interface; and
the controller is configured to: acquire voltage information of the energy storage module when the connection status indicates that the power interface is connected to the external power supply and the photovoltaic assembly generates electrical energy; and determine, based on the voltage information of the energy storage module, first output voltage information of the photovoltaic charging module and second output voltage information of the DC charging module, wherein the first output voltage information and the second output voltage information are larger than the voltage information of the energy storage module.

13. The device according to claim 12, wherein:
the photovoltaic charging module is configured to supply power to the electronic assembly based on the first output voltage information, and/or charge the energy storage module based on the first output voltage information.

14. The device according to claim 13, wherein:
the DC charging module is configured to supply power to the electronic assembly based on the second output voltage information, and/or charge the energy storage module based on the second output voltage information.

15. The device according to claim 1, wherein:
the photovoltaic assembly includes a photovoltaic charging module and a photovoltaic unit;
the photovoltaic charging module includes a photovoltaic charging management module; and
the controller is configured to: acquire current information and voltage information of the photovoltaic unit; determine a maximum input power of the photovoltaic unit based on the current information and voltage information of the photovoltaic unit; and determine a power supply strategy of the photovoltaic charging management module based on the maximum input power of the photovoltaic unit.

16. The device according to claim 15, wherein the controller is further configured to:
determine a target power range from a plurality of predetermined power ranges based on the maximum input power of the photovoltaic unit; and
determine an output current range corresponding to the target power range as the power supply strategy of the photovoltaic charging management module.

17. The device according to claim 16, wherein:
the controller is connected to the photovoltaic charging management module via a plurality of fourth switch modules, wherein a number of the plurality of fourth switch modules corresponds to a number of the plurality of power ranges;
the photovoltaic charging module further includes a fifth switch module;
the controller is configured to: turn on one of the plurality of fourth switch modules corresponding to the target power range; and
the photovoltaic charging management module is configured to turn on the fifth switch module based on a high-level signal generated by turning on the one of the plurality of fourth switch modules, such that a current value passing through the fifth switch module is within the output current range.

18. The device according to claim 16, further comprising a power limitation module, wherein:
the controller is configured to: determine a power limitation range of the electronic assembly based on the target power range of the photovoltaic unit; and send the power limitation range of the electronic assembly to the power limitation module; and
the power limitation module is configured to limit a load power of the electronic assembly based on the power limitation range.

19. The device according to claim 14, wherein:
the photovoltaic assembly includes a photovoltaic charging module and a photovoltaic unit;
the photovoltaic charging module includes a photovoltaic charging management module; and
the controller is configured to: acquire current information and voltage information of the photovoltaic unit; determine a maximum input power of the photovoltaic unit based on the current information and voltage information of the photovoltaic unit; and determine a power supply strategy of the photovoltaic charging management module based on the maximum input power of the photovoltaic unit.

20. The device according to claim 19, wherein the controller is further configured to:
determine a target power range from a plurality of predetermined power ranges based on the maximum input power of the photovoltaic unit; and
determine an output current range corresponding to the target power range as the power supply strategy of the photovoltaic charging management module.
